(19) United States
(12) Patent Application Publication
(10) Pub. No.: US 2025/0387890 A1
(43) Pub. Date: Dec. 25, 2025

(54) Puller

(71) Applicant: ARESTOOL CO., LTD., Taichung City (TW)

(72) Inventor: LIANG-HUI LIN, Taichung City (TW)

(21) Appl. No.: 18/753,103

(22) Filed: Jun. 25, 2024

(51) Int. Cl. B25B 27/02

(52) U.S. Cl. CPC B25B 27/023

(57) ABSTRACT

A puller is provided, wherein the puller includes: a main body including engaging portions and a threaded hole, each engaging portions including an engaging slot which is laterally open and includes an elastic detent portion including an engaging structure; a bolt screwed to the threaded hole; and claws each detachably assembled to one of the engaging portions, each claw including a shaft portion rotatably engaged in the engaging slot and a positioning section, the positioning section including a concave-convex structure arranged around the shaft portion and being releasably restricted by the engaging structure, wherein when a central vertical line of the positioning section is parallel to the bolt, the central vertical line divides the concave-convex structure into first and second section, and radian angles of the first and second sections extending around the shaft portion are different relative to the center of the shaft portion.

### BACKGROUND OF THE INVENTION

### FIELD OF THE INVENTION

The present invention relates to a pulling device, in particular to puller.

### DESCRIPTION OF THE PRIOR ART

The general structure of a conventional puller, such as one disclosed in patent number TW 430027, includes a base and a plurality of claws. A threaded shaft is screwed to the base, and the end of the threaded shaft includes a pressing member. In operation, the threaded shaft is rotated to move the plurality of claws to remove an object.

However, the plurality of claws of the above structure cannot be directly detached or assembled. Therefore, when the plurality of claws are worn out or damaged, the puller must be discarded because the plurality of claws cannot be replaced, making it inconvenient to use. Additionally, the plurality of claws of the above structure cannot securely hook the object, causing the plurality of claws to easily slip from the object. Furthermore, reducing the material usage to lower manufacturing costs is another problem to be solved.

The present invention is, therefore, arisen to obviate or at least mitigate the above-mentioned disadvantages.

### SUMMARY OF THE INVENTION

The main object of the present invention is to provide a puller which allows claws to be directly assembled or detached, which provides convenient assembly and usage.

To achieve the above and other objects, a puller is provided, wherein the puller includes: a main body including a plurality of engaging portions and a threaded hole, each of the plurality of engaging portions including an engaging slot which is laterally open and includes an elastic detent portion, the elastic detent portion including an engaging structure; a bolt screwed to the threaded hole; and a plurality of claws each detachably assembled to one of the plurality of engaging portions, each of the plurality of claws including a shaft portion and a positioning section, the shaft portion being rotatably engaged in the engaging slot, one end of the positioning section including a concave-convex structure arranged around the shaft portion, the concave-convex structure being releasably restricted by the engaging structure, wherein when a central vertical line of the positioning section is parallel to the bolt, the central vertical line divides the concave-convex structure into a first section and a second section, and radian angles of the first section and the second section extending around the shaft portion are different relative to the center of the shaft portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a side view of a claw of an exemplary embodiment of the present invention;

FIG. 4 is a cross-sectional view of an exemplary embodiment of the present invention; and

FIG. 5 is another stereogram of an exemplary embodiment of the present invention.

### DETAILED DESCRIPTION OF THE PREFERRED EMBODIMENT S

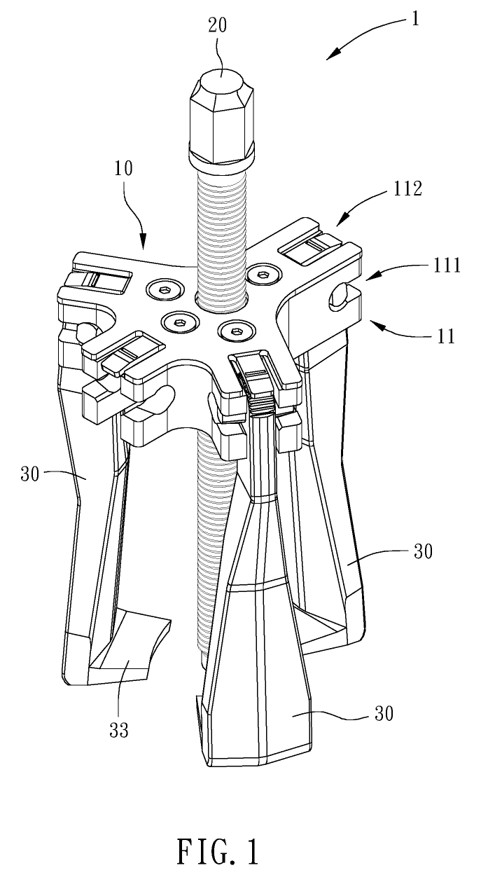

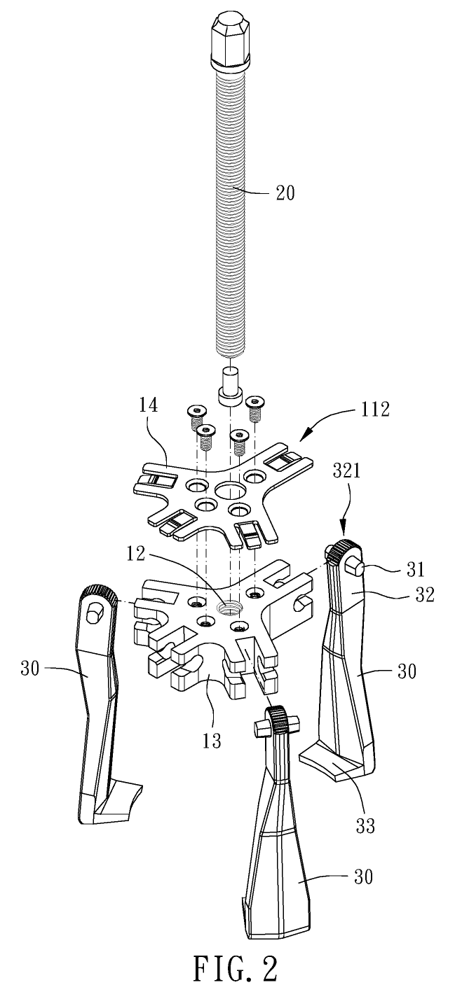

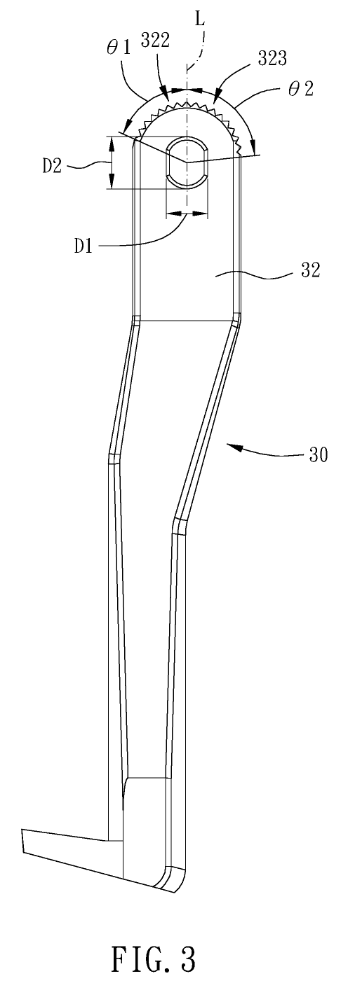

Please refer to FIGS. 1 to 4 for an exemplary embodiment of the present invention. A puller 1 of the present invention includes a main body 10, a bolt 20, and a plurality of claws 30.

The main body 10 includes a plurality of engaging portions 11 and a threaded hole 12, each of the plurality of engaging portions 11 includes an engaging slot 111 which is laterally open and includes an elastic detent portion 112, and the elastic detent portion 112 includes an engaging structure 113. The bolt 20 is screwed to the threaded hole 12. The plurality of claws 30 are each detachably assembled to one of the plurality of engaging portions 11, each of the plurality of claws 30 includes a shaft portion 31 and a positioning section 32, the shaft portion 31 is rotatably engaged in the engaging slot 111, one end of the positioning section 32 includes a concave-convex structure 321 arranged around the shaft portion 31, and the concave-convex structure 321 is releasably restricted by the engaging structure 113. When a central vertical line L of the positioning section 32 is parallel to the bolt 20, the central vertical line L divides the concave-convex structure 321 into a first section 322 and a second section 323, and radian angles of the first section 322 and the second section 323 extending around the shaft portion 31 are different relative to the center of the shaft portion 31. Therefore, the plurality of claws 30 can be directly assembled to or detached from the main body 10, providing convenient assembly and usage.

In this embodiment, the main body 10 includes a base 13 and a cover 14. The cover 14, for example, may be detachably assembled to the base 13 with screws; however, the main body 10 may be integrally formed to reduce the number of components and cost. The hardness of the base 13 is HRC40±4, the hardness of the cover 14 is HRC47±3, the hardness of the bolt 20 is HRC41±4, and the hardness of each of the plurality of claws 30 is HRC45±5. The base 13, the cover 14, the bolt 20, and each of the plurality of claws 30 are, for example, made of steel (alloy steel, medium carbon steel, high carbon steel, spring steel, etc.). The cover 14 is relatively thin and has a higher hardness to provide sufficient and stable engaging effects for the plurality of claws 30. The relatively high hardness of each of the plurality of claws 30 ensures that they are not easily deformed or damaged.

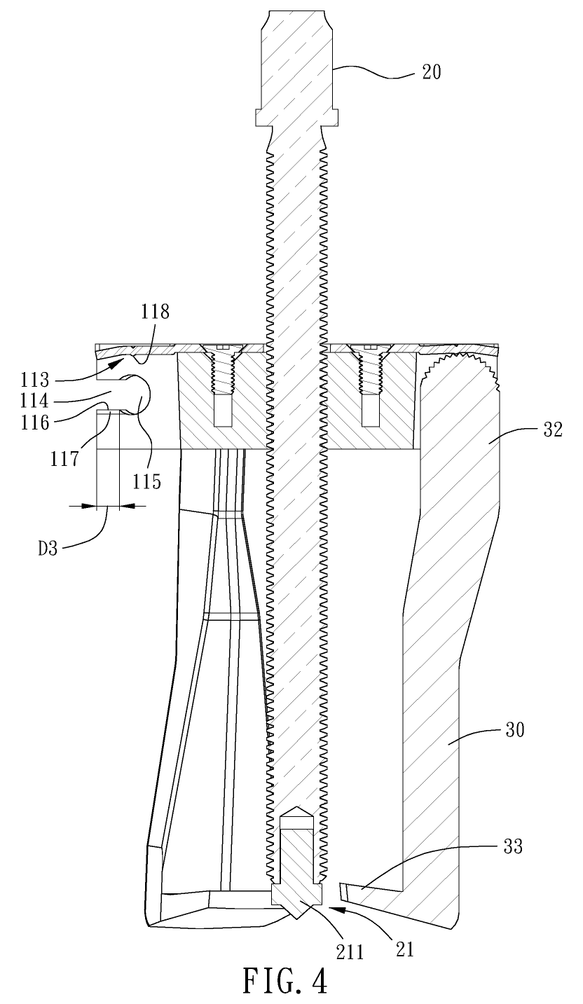

The engaging slot 111 includes a passageway 114 and a pivot hole 115 from the outer side to the inner side of the main body 10, and the shaft portion 31 is inserted from the passageway 114 into the pivot hole 115 and pivotally engaged in the pivot hole 115. The passageway 114 is narrower than the pivot hole 115. The shaft portion 31 has a small diameter D1 and a large diameter D2, the small diameter D1 allows the shaft portion 31 to pass through the passageway 114 into the pivot hole 115, the large diameter D2 is greater than the width of the passageway 114 to restrict the shaft portion 31 in the pivot hole 115. The passageway 114 includes a side plane 116 extending radially toward the pivot hole 115, and there is a chamfer 117 (FIG. 4) between the side plane 116 and a side of the passageway 114 close to the positioning section 32. The distance radially extending from the side plane 116 toward the pivot hole 115 is defined as a width dimension D3, and the width dimension D3 is not less than 0.75 times the large diameter D2. Thus, even if the shaft portion 31 is partially located in the passageway 114 during operation, it can be prevented from accidentally slipping out of the engaging slot 111, providing excellent reliability. In this embodiment, the pivot hole 115 extends arcedly in the direction around the bolt 20 (FIG. 4), and the shaft portion 31 gradually tapers outwardly from the positioning section 32. Because the pivot hole 115 and the shaft portion 31 are shaped to match with each other and the passageway 114 has the chamfer 117, during pulling, the shaft portion 31 which is generally conical will be automatically guided to the centered position to receive balanced force when it contacts the side wall of the engaging slot 111. The shaft portion 31 engages the side wall of the engaging slot 111 at the root position which is adjacent to the positioning section 32 and has the maximum structural strength, thus effectively preventing breakage of the shaft portion 31.

Preferably, the end of the bolt 20 is detachably assembled with an insert 21, which allows replacement of an appropriate insert depending on the object to be removed. A head 211 of the insert 21 extends axially beyond a threaded portion of the bolt 20, and the head 211 extends radially beyond a tooth root position of the threads of the threaded portion, thus avoiding damage to the threaded portion of the bolt 20 during removal operations.

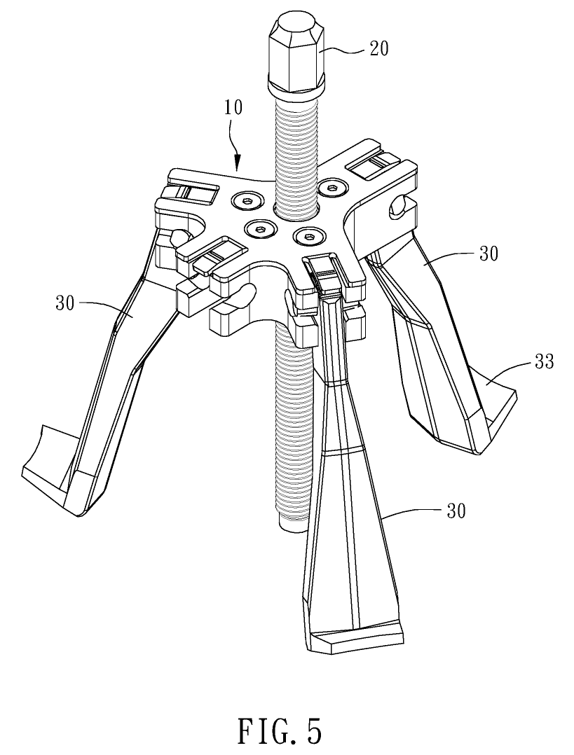

In this embodiment, the engaging structure 113 includes at least one projection 118 or at least one tooth, and the concave-convex structure 321 includes a plurality of teeth 324 and a plurality of grooves 325. The at least one projection 118 can be releasably engaged within one of the plurality of grooves 325. As such, after the plurality of claws 30 swing to adjust its position, they can be held in position and prevented from slipping during pulling. Each of the plurality of claws 30 has a foot 33 protruding laterally towards the positioning section 32 for hooking an object. It may be arranged so that the foot 33 extends inward (FIG. 1) or outward (FIG. 5). The first section 322 and the foot 33 are located at the same side of the central vertical line L, but the first section 322 and the foot 33 can also be on opposite sides of the central vertical line L.

Preferably, the radian angle θ1 of the first section 322 extending around the shaft portion 31 is from 60 degrees to 125 degrees, and the radian angle θ2 of the second section 323 extending around the shaft portion 31 is from 65 degrees to 135 degrees. For example, the radian angle θ1 of the first section 322 extending around the shaft portion 31 is 70 degrees, and the radian angle θ2 of the second section 323 extending around the shaft portion 31 is 90 degrees. The larger radian angle θ2 of the second section 323 ensures that the plurality of claws 30 can maintain positioning even when swinging outward at a large angle, and it can prevent the plurality of claws 30 from accidentally disengaging from the engaging slot 111.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A puller including:
a main body including a plurality of engaging portions and a threaded hole, each of the plurality of engaging portions including an engaging slot which is laterally open and includes an elastic detent portion, the elastic detent portion including an engaging structure;
a bolt screwed to the threaded hole; and
a plurality of claws each detachably assembled to one of the plurality of engaging portions, each of the plurality of claws including a shaft portion and a positioning section, the shaft portion being rotatably engaged in the engaging slot, one end of the positioning section including a concave-convex structure arranged around the shaft portion, the concave-convex structure being releasably restricted by the engaging structure, wherein when a central vertical line of the positioning section is parallel to the bolt, the central vertical line divides the concave-convex structure into a first section and a second section, and radian angles of the first section and the second section extending around the shaft portion are different relative to the center of the shaft portion.

2. The puller of claim 1, wherein an end of the bolt is detachably assembled with an insert, a head of the insert extending axially beyond a threaded portion of the bolt, and the head extends radially beyond a tooth root position of threads beyond the threaded portion.

3. The puller of claim 1, wherein each of the plurality of claws has a foot protruding laterally towards the positioning section, and the first section and the foot are located at the same side of the central vertical line.

4. The puller of claim 1, wherein the main body includes a base and a cover, the cover being detachably assembled to the base, the hardness of the base being HRC40±4, the hardness of the cover being HRC47±3, the hardness of the bolt being HRC41±4, and the hardness of each of the plurality of claws being HRC45±5.

5. The puller of claim 1, wherein the radian angle of the first section extending around the shaft portion is from 60 degrees to 125 degrees, and the radian angle of the second section extending around the shaft portion is from 65 degrees to 135 degrees.

6. The puller of claim 5, wherein the radian angle of the first section extending around the shaft portion is 70 degrees, and the radian angle of the second section extending around the shaft portion is 90 degrees.

7. The puller of claim 1, wherein the engaging slot includes a passageway and a pivot hole from an outer side to an inner side of the main body, the shaft portion is inserted from the passageway into the pivot hole and pivotally engaged in the pivot hole, and the passageway is narrower than the pivot hole.

8. The puller of claim 7, wherein the shaft portion has a small diameter and a large diameter, the passageway includes a side plane extending radially toward the pivot hole, there is a chamfer between the side plane 116 and a side of the passageway close to the positioning section, the distance radially extending from the side plane toward the pivot hole is defined as a width dimension, and the width dimension is not less than 0.75 times the large diameter.

9. The puller of claim 7, wherein the pivot hole extends in an arc shape in the direction of the bolt.

10. The puller of claim 1, wherein the shaft portion gradually tapers outwardly from the positioning section.
